(19) United States
(12) Patent Application Publication
(10) Pub. No.: US 2020/0227774 A1
(43) Pub. Date: Jul. 16, 2020

(54) GRADATIONAL ACTIVE MATERIAL - SOLID ELECTROLYTE INTERFACE

(71) Applicants: Chongqing Jinkang New Energy Automobile Co., Ltd., Chongqing (CN); SF Motors Inc., Santa Clara, CA (US)

(72) Inventor: Yasuo Nakahara, Kakogawa City (JP)

(21) Appl. No.: 16/245,201

(22) Filed: Jan. 10, 2019

(51) Int. Cl. H01M 10/0562; H01M 10/0525; H01M 10/058; H01M 4/36

(52) U.S. Cl. CPC H01M 10/0562; H01M 10/0525; H01M 2300/0068; H01M 4/364; H01M 10/058

(57) ABSTRACT

Various solid-state battery cell arrangements and methods are presented. An anode current collector and anode may be present. A solid electrolyte may be present that is formed using an electrolyte material. A gradational interface located between the solid electrolyte and the anode may be formed. The gradational interface may include a mixture of the electrolyte material and the anode material. The gradational interface can include a greater percentage of the electrolyte material in a first portion of the gradational interface that contacts the solid electrolyte than a second portion of the gradational interface that contacts the anode.

### BACKGROUND

In a solid-state battery cell, a solid electrolyte is positioned between an anode and a cathode. The interface between the cathode and solid electrolyte and the interface between the anode and the solid electrolyte can significantly affect the performance of the battery cell. If poor contact is present at either or both of these interfaces, the performance of the battery cell may be degraded. Further, contact may worsen over repeated charge and discharge cycles of the battery cell.

### SUMMARY

Various embodiments are described that are related to solid-state battery cells. In some embodiments, a solid-state battery cell is described. The device may include an anode current collector. The device may include an anode attached to the anode current collector. The anode may be formed using an anode material. The device may include a solid electrolyte formed using an electrolyte material. The device may include a gradational interface located between the solid electrolyte and the anode. The gradational interface may include a mixture of the electrolyte material and the anode material. The gradational interface may include a greater percentage of the electrolyte material in a first portion of the gradational interface that may contact the solid electrolyte than a second portion of the gradational interface that may contact the anode. The device may include a cathode. The device may include a cathode current collector.

Embodiments of such device may include one or more of the following features: the gradational interface may include a greater percentage of the anode material in the second portion of the gradational interface that may contact the anode than the first portion of the gradational interface contacting the solid electrolyte. The mixture of the gradational interface may be a continuous gradient mixture from being exclusively composed of anode material contacting the anode to being exclusively composed of solid electrolyte material that may contact the solid electrolyte. The mixture of the gradational interface may be a stepped gradient mixture that may include a plurality of layers. Each layer may include a different percentage of the anode material. The device may further include a second gradational interface located between the solid electrolyte and the cathode. The second gradational interface may include a second mixture of the electrolyte material and a cathode material. The gradational interface may include a greater percentage of the electrolyte material in a first portion of the second gradational interface that may contact the solid electrolyte than a second portion of the second gradational interface that may contact the cathode. The second gradational interface may include a greater percentage of the cathode material in the second portion of the second gradational interface that may contact the cathode than the first portion of the gradational interface that may contact the solid electrolyte. The mixture of the second gradational interface may be a continuous gradient mixture from being exclusively composed of cathode material that may contact the cathode to being exclusively composed of solid electrolyte material that may contact the solid electrolyte. The mixture of the second gradational interface may be a stepped gradient mixture that may include a plurality of layers. Each layer may include a different percentage of the cathode material. The solid-state battery cell may be a lithium ion solid-state battery cell.

In some embodiments, a method for creating an electrolyte interface for a solid-state battery is described. The method may include creating an anode made from an anode material. The method may include creating an interface layer between the anode and an electrolyte layer. The method may include creating a first mixture of the anode material and an electrolyte material. The method may include creating a second mixture of the anode material and the electrolyte material. The first mixture may have a greater concentration of anode material than the second mixture. The method may include depositing the first mixture on the anode. The method may include depositing the second mixture on the first mixture. The method may include creating the electrolyte layer using the electrolyte material. The method may include creating a cathode using a cathode material.

Embodiments of such a method may include one or more of the following features: the method may include placing the electrolyte layer in contact with the second mixture. The interface layer may be a stepped gradient mixture that may include a plurality of layers. Each layer may include a different percentage of the anode material. The method may include creating a second interface layer between the cathode and the electrolyte layer. The method may include creating a third mixture of the cathode material and the electrolyte material. The method may include creating a fourth mixture of the cathode material and the electrolyte material. The third mixture may have a greater concentration of cathode material than the fourth mixture. The method may further include depositing the fourth mixture on the electrolyte layer. The method may include depositing the third mixture on the fourth mixture. The second interface layer may be a second stepped gradient mixture that may include a plurality of layers. Each layer may include a different percentage of the cathode material. The method may include placing the cathode in contact with the third mixture. The method may include placing a cathode current collector in contact with the cathode. The method may create a lithium ion solid-state battery cell.

In some embodiments, a method for creating an electrolyte interface for a solid-state battery is described. The method may include creating a cathode made from a cathode material. The method may include creating an interface layer between the cathode and an electrolyte layer. The method may include creating a first mixture of the cathode material and an electrolyte material. The method may include creating a second mixture of the cathode material and the electrolyte material. The first mixture may have a greater concentration of cathode material than the second mixture. The method may include depositing the first mixture on the cathode. The method may include depositing the second mixture on the first mixture. The method may include creating the electrolyte layer using the electrolyte material.

Embodiments of such a method may include one or more of the following features: the interface layer may be a stepped gradient mixture that may include a plurality of layers. Each layer may include a different percentage of the cathode material.

### BRIEF DESCRIPTION OF THE DRAWINGS

FIG. 1 illustrates an embodiment of a solid-state battery.

FIG. 2 illustrates an embodiment of a solid-state battery cell 200 having gradational active material—solid electrolyte interfaces.

FIG. 3 illustrates an embodiment of a continuous gradational active material—solid electrolyte interface.

FIG. 4 illustrates an embodiment of a stepped gradational active material—solid electrolyte interface.

FIG. 5 illustrates an embodiment of a method for creating a gradational anode—solid electrolyte interface.

FIG. 6 illustrates an embodiment of a method for creating a gradational cathode—solid electrolyte interface.

### DETAILED DESCRIPTION

In a solid-state battery cell, the contact between an active material (either the anode or cathode) and the solid-state electrolyte may affect the performance characteristics of a battery cell, such as the battery cell's power density and durability. A good interface between the active material and the solid-state electrolyte may be dense, have a high ionic conductivity, and/or be mechanically and thermally stable. Further, this interface should not substantially degrade through battery cell charge and discharge cycles.

As detailed herein, interface regions may be created between an anode and the electrolyte and/or between the electrolyte and the cathode. These interface regions may be dense, have a high ionic conductivity, exhibit little degradation through multiple charge and discharge cycles and be mechanically and thermally stable. Such interface regions may increase the durability of a battery cell and/or increase the power density of the battery cell. Each interface region may be continuous or stepped gradient from electrolyte material to anode material (for the interface between the anode and the electrolyte) or to the cathode material (for the interface between the cathode and the electrolyte). Therefore, the concentration of the solid-state electrolyte material increases within the interface as the distance to the electrolyte decreases. Similarly, the concentration of the active material (either anode material or cathode material) increases as the distance to the active material within the interface region decreases.

By forming such a structure in which a continuous or stepped gradient is present between the active material and the solid-state electrolyte, affinity between the active material layer and the solid electrolyte layer is increased and differences in the properties of active material and the solid-state electrolyte have less of an effect on the contact between the active material and the solid-state electrolyte. In addition, reaction products that can result from a reaction between the active material and the solid electrolyte are produced less such that the interface between the active material and the solid-state electrolyte is better.

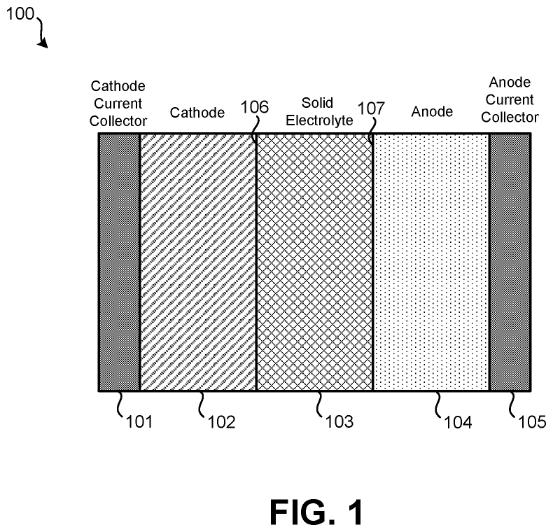

Further detail is provided to relation to the figures. FIG. 1 illustrates an embodiment of a solid-state battery cell 100. Solid-state battery cell 100 may include cathode current collector 101; cathode 102; solid-state electrolyte 103; anode 104; and anode current collector 105. Cathode current collector 101 may be a metallic material that evenly receives and disperses current across contact with cathode 102. Cathode current collector 101 may be made from a metal such as aluminum or copper. Similarly, anode current collector 105 may be a metallic material that helps evenly receives and disperses current across contact with anode 104. Anode current collector 105 may be made from a metal such as copper.

Cathode 102, solid-state electrolyte 103, and anode 104 may each be made from a solid material. Hence, solid-state battery cell 100 is considered solid-state. For the cathode active material, lithium metal oxide such as LiCoO₂ (LCO), LiNi_{0.8}Co_{0.15}Al_{0.05}O₂ (NCA), and LiNiₓMn_{y}Co_{z}O₂, where x+y+z=1 (NMC) can be used. For anode active material, carbon materials such as graphite, hard carbon, and soft carbon, lithium titanate, or metallic lithium can be used. For solid-state electrolyte, sulfur-based materials such as thio-LISICONs (Lithium Super Ionic CONductors) that include LiGePS (LGPS), Li₂S—P₂S₅ (LPS), Li_{9.54}Si_{1.74}P_{1.44}S_{11.7}Cl_{0.3}, and oxide such as LISICONs that include Li1₄ZnGe₄O₁₆, Li₇La₃Zr₂O₁₂ (LLZO) can be used.

Cathode 102 may have a first surface pressed against cathode current collector 101 and a second surface pressed against solid-state electrolyte 103. Anode 104 may have a first surface pressed against anode current collector 105 and a second surface pressed against solid-state electrolyte 103. Interface 106, which represents the contact between cathode 102 and solid-state electrolyte 103 may be altered to improve performance of solid-state battery cell 100. Additionally or alternatively, interface 107, which represents the contact region between anode 104 and solid-state electrolyte 103 may be alerted to improve performance of the solid-state battery cell 100. In the illustrated example of solid-state battery cell 100, interface 106 and interface 107 are mere surfaces where the active material (cathode material or anode material) is adjacent to solid-state electrolyte 103.

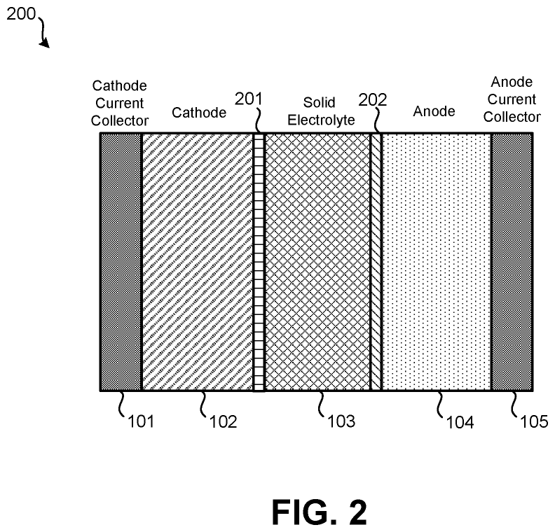

FIG. 2 illustrates an embodiment of a solid-state battery cell 200 having gradational active material—solid electrolyte interfaces. Solid-state battery cell 200 may be a modified version of solid-state battery cell 100. In solid-state battery cell 200, in contrast to solid-state battery cell 100, interface region 201 and interface region 202 are present. Interface region 201 represents a transition between the cathode material used to create cathode 102 and solid-state electrolyte 103. Interface region 201 may be made of both cathode material and solid electrolyte material. Interface region 202 represents a transition between the anode material used to create anode 104 and solid-state electrolyte 103. Interface region 202 may be made of both anode material and solid electrolyte material.

Solid-state battery cell 200 may be formed from a layers being deposited on a substrate. In some embodiments, the layer arrangement of solid-state battery cell 200 may be rolled to create a jelly-roll style battery cell that can be housed in a cylindrical housing. In other embodiments, a planar pouch-style battery cell may be created.

While solid-state battery cell 200 is illustrated as having both interface region 201 and interface region 202, in other embodiments only interface region 201 or interface region 202 may be present. It should be understood that the illustrated thicknesses of solid-state battery cell 200 are not to scale.

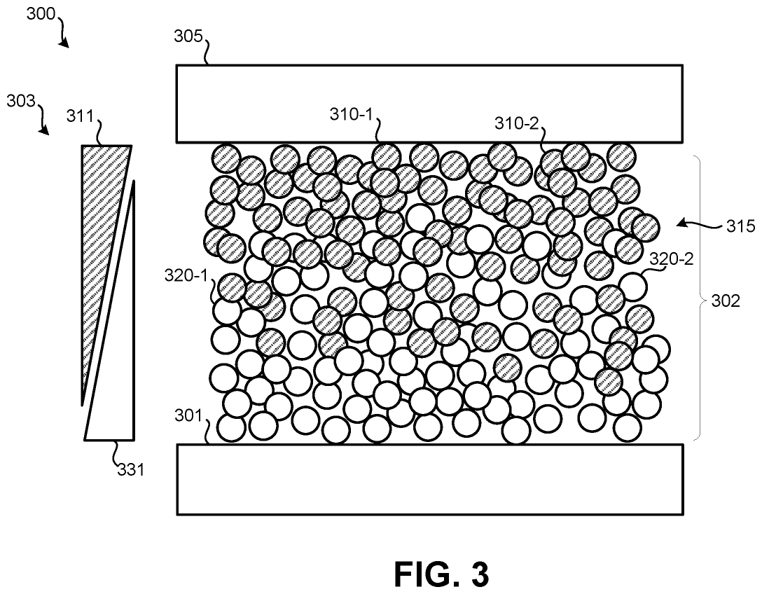

Interface region 201 and interface region 202 of solid-state battery cell 200 each can include gradients of material. FIG. 3 illustrates an embodiment 300 of a gradational active material—solid electrolyte interface. Embodiment 300 can include active material 301; active material particles 320 (320-1, 320-2); and electrolyte particles 310 (310-1, 310-2). For simplicity, only a small number of active material particles and electrolyte particles are specifically labelled.

Active material 301 may represent the anode or the cathode. The anode may be formed from exclusively or substantially an anode material. The cathode may be formed from exclusively or substantially a cathode material. In some embodiments, the cathode, anode, or both may have a low ionic conductivity. In such circumstances, some solid electrolyte may be added in the vicinity of the interface with anode current collector 105, cathode current collector 101, or both. Interface region 302, however, may be a gradient that transitions from exclusively or nearly exclusively active material particles (particles made of the same active material as the anode or cathode as present at active material 301) closest to active material 301 to exclusively or nearly exclusively electrolyte particles farthest from active material 301 and closest to solid-state electrolyte 305. Embodiment 300 represents a continuous gradient, as indicated by abstraction 303. Abstraction 303 indicates that the percentage or concentration of active material particles 331 continuously decreases as the distance from active material 301 increases within interface region 302. Similarly, abstraction 303 indicates that the percentage or concentration of electrolyte material particles 311 increases as the distance from active material 301 increases within interface region 302.

Positioned atop interface region 302 may be exclusive or substantially solid-state electrolyte material that forms solid-state electrolyte 103 of FIG. 2. Stated a different way, abstraction 303 indicates that the percentage or concentration of active material particles 331 continuously decreases as the distance to the solid-state electrolyte decreases within interface region 302. Similarly, abstraction 303 indicates that the percentage or concentration of electrolyte material particles 311 increases as the distance to the solid-state electrolyte 305 decreases within interface region 302. As a simple example, at the midpoint within interface region 302, the interface may be made of 50% electrolyte particles and 50% active material particles; at 75% of the distance from active material 301 to solid-state electrolyte 305, indicated by location 315, the interface may be made from 75% electrolyte material and 25% active material. In other embodiments, the rate at which the percentage or concentration of active material decreases as the distance from active material 301 increases may be a different rate than the example or a non-linear rate. Similarly, the rate at which the percentage or concentration of the solid-state electrolyte material increases as the distance from active material 301 increases may be a different rate than the example or a non-linear rate.

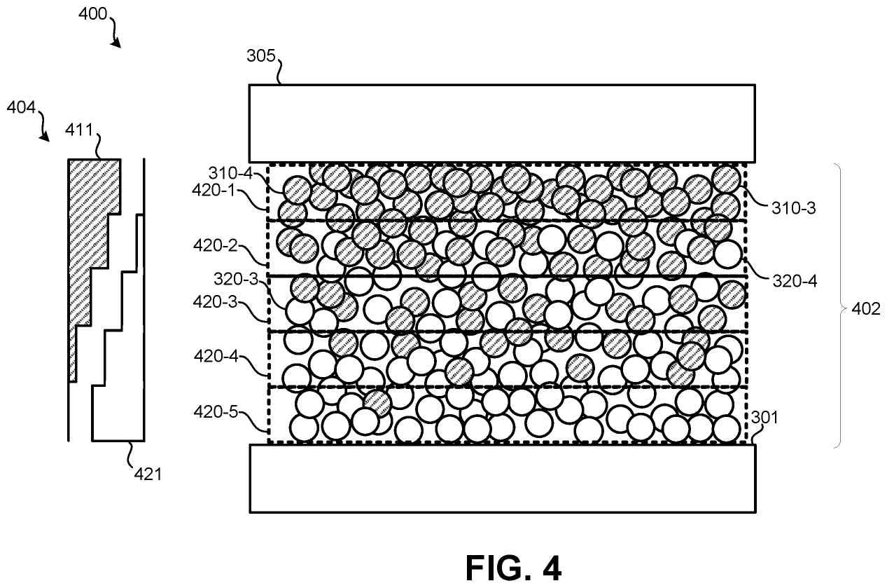

In other embodiments, rather than a continuous gradient of active material to solid-state electrolyte material being present, a stepped gradient may be present. FIG. 4 illustrates an embodiment 400 of a stepped gradational active material—solid electrolyte interface. In embodiment 400, various sub-regions 420 (420-1, 420-2, 420-3, 420-4, 420-5) are present within interface region 402.

Each of the sub-regions 420 that form interface region 402 may include a fixed mixture of electrolyte particles and active material particles. The concentration or percentage of active material particles in the sub-regions may increase as the distance to active material 301 decreases. Similarly, the concentration or percentage of solid-state electrolyte material particles in the sub-regions may increase as the distance to solid-state electrolyte 305 decreases. As an example, sub-region 420-1 may include, for example, 95% electrolyte material particles and 5% active material particles; sub-region 420-2 may include 75% electrolyte material particles and 25% active material particles; sub-region 420-3 may include 50% electrolyte material particles and 50% active material particles; sub-region 420-4 may include 25% electrolyte material particles and 75% active material particles; and sub-region 420-5 may include 5% electrolyte material particles and 95% active material particles.

As illustrated in abstraction 404, each of sub-regions 420 has a different percentage or concentration of solid-state electrolyte particles and active material particles. In abstraction 404, the concentration or percentage of solid electrolyte material particles is illustrated by electrolyte particle percentage 411 and the concentration or percentage of active material particles is illustrated by active material percentage 421. While each sub-region of sub-regions 420 has a different fixed mixture, the layered effect of multiple sub-regions is of a stepped gradient. The number of layers may vary to be greater than five or fewer than five by embodiment. For example, in some embodiments a single layer may be present; in other embodiments, ten layers may be present.

In illustrated embodiment 400, each of sub-regions 420 are the same thickness; in other embodiments, the thicknesses of sub-regions 420 may be varied. For example, sub-region 420-1 may be made substantially thinner or thicker than sub-region 420-3.

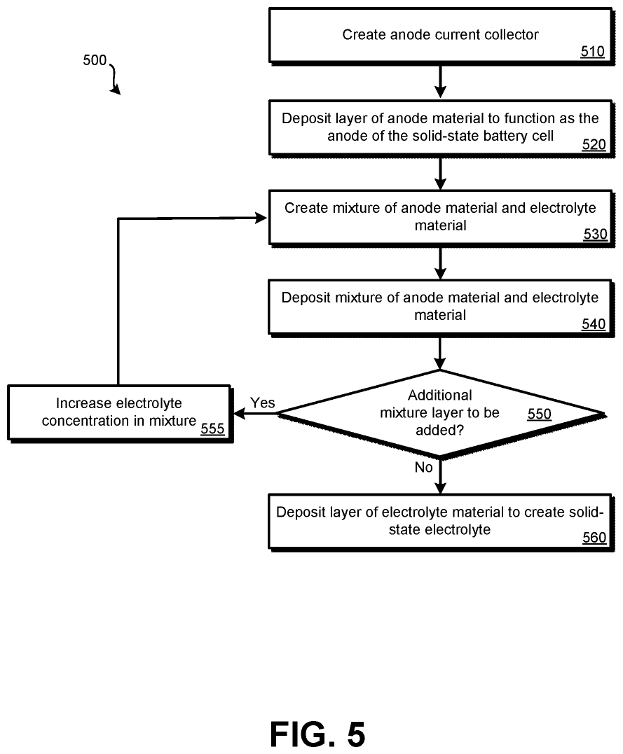

Various methods may be performed to create the embodiments of FIGS. 2-4. FIG. 5 illustrates an embodiment of a method 500 for creating a gradational anode—solid electrolyte interface. In method 500, the active material is an anode material. However, in other embodiments, a cathode material may be used instead.

At block 510, an anode current collector may be created. This may involve a metallic layer being created either through deposition or by a sheet or piece of metal being shaped, stamped, or otherwise made to desired dimensions. In some embodiments, the anode current collector is attached at a later time and, thus method 500 may begin with block 520.

At block 520, a layer of only or substantially anode material may be deposited on the anode current collector. The anode material may be a rolled sheet of anode material that is layered atop the anode current collector. Alternatively, a layer of anode material may be deposited onto the anode current collector. The anode material may be deposited in the form of a slurry then dried or may be deposited in the form of a dry powder then sintered to form a solid layer that functions as the anode.

At blocks 530-555 an interface between the anode and solid electrolyte may be created. At block 530, a first mixture of anode material and electrolyte material may be made. The mixture may be a dry mixture or a slurry mixture. The first mixture may have a high percentage of anode material as compared to the electrolyte material since the first mixture will be applied directly to the anode deposited at block 520. Subsequent mixtures may each have a decreasing percentage of anode material as the distance from the anode of block 520 increases. At block 540, the mixture of block 530 may be deposited. If the mixture is dry, the mixture may then be sintered. Alternatively, sintering may be performed after more than one or all of the interface layers have been deposited. In other embodiments in which a slurry mixture is used, the slurry may be deposited onto the anode of block 520 then dried.

At block 550, if it is determined that an additional mixture layer is to be added to the interface region between the anode and the solid-state electrolyte, method 500 may proceed to block 555. At block 555, the percentage or concentration of the solid-electrolyte material particles in the mixture is increased relative to the amount of anode material particles. In some embodiments, a manufacturer may generate some number of mixtures and then apply each mixture as consecutive layers to create a gradient that transitions from primarily anode material to primarily electrolyte material. Blocks 530-555 may repeat until the interface region has been fully formed.

At block 560, a layer of exclusively or primarily electrolyte material may be deposited to form the solid-state electrolyte. The solid-state electrolyte deposited at block 560 may be deposited in the form of a powered then sintered or as a slurry then dried. Following method 500 being performed, solid-state electrolyte 103, interface region 202, anode 104, and, possibly, anode current collector 105 as illustrated in FIG. 2 may be present. It should be understood that method 500 may be reversed such that the electrolyte is deposited first, followed by an interface region that increases a concentration of anode material as the distance from the electrolyte increase, then an anode is created on the interface region.

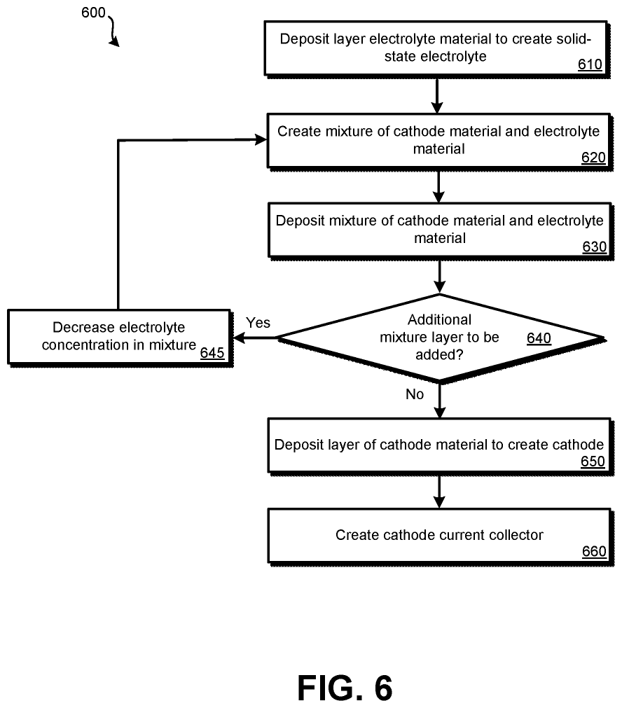

While method 500 focuses on an interface region between an anode and an electrolyte of a solid-state battery cell, FIG. 6 illustrates an embodiment of a method for creating a gradational cathode—solid electrolyte interface. Method 600 may be performed as part of manufacturing the same battery cell of method 500.

At block 610, a layer of exclusively or primarily electrolyte material may be deposited to form the solid-state electrolyte. The solid-state electrolyte deposited at block 560 may be deposited in the form of a powered then sintered or as a slurry then dried. If method 600 is being performed in combination with method 500, block 610 may have been performed at block 560 of method 500.

At blocks 620-645 an interface between the cathode and the solid-state electrolyte may be created. At block 620, a first mixture of cathode material and electrolyte material may be made. The mixture may be a dry mixture or a slurry mixture. The first mixture may have a high percentage of electrolyte material particles as compared to the cathode material since the first mixture will be applied directly to the solid-state electrolyte deposited at block 610. Subsequent mixtures may each have a decreasing percentage of electrolyte material as the distance from the solid-state electrolyte of block 610 increases. At block 630, the mixture of block 620 may be deposited. If the mixture is dry, the mixture may then be sintered. Alternatively, sintering may be performed after more than one or all of the interface layers have been deposited. In other embodiments in which a slurry mixture is used, the slurry may be deposited onto the solid-state electrolyte of block 610 then dried.

At block 640, if it is determined that an additional mixture layer is to be added to the interface region between the cathode and the solid-state electrolyte, method 600 may proceed to block 645. At block 645, the percentage or concentration of the solid-electrolyte material particles in the mixture is decreased relative to the amount of cathode material particles. In some embodiments, a manufacturer may create some number of mixtures and then apply each mixture as consecutive layers to create a gradient that transitions from primarily solid-state electrolyte material to primarily cathode material. Blocks 620-645 may repeat until the interface region between the solid-state electrolyte and the cathode has been fully formed.

At block 650, a layer of only or substantially cathode material may be deposited onto the interface region created at blocks 620-645. The cathode material may be a rolled sheet of cathode material that is layered atop the anode current collector. Alternatively, a layer of cathode material may be deposited onto the interface region. The cathode material may be deposited in the form of a slurry then dried or may be deposited in the form of a dry powder then sintered to form a solid layer that functions as the cathode.

At block 610, a cathode current collector may be created. This may involve a metallic layer being created either through deposition or by a sheet or piece of metal being shaped, stamped, or otherwise made to desired dimensions. In some embodiments, the cathode current collector is attached at a later time and, thus method 600 may end with block 650.

It should be understood that method 600 may be reversed such that the cathode is created or deposited first, followed by an interface region that increases a concentration of electrolyte material as the distance from the cathode increase, then a solid-state electrolyte is created on the interface region.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner.

Specific details are given in the description to provide a thorough understanding of example configurations (including implementations). However, configurations may be practiced without these specific details. For example, well-known processes, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A solid-state battery cell, comprising:
an anode current collector;
an anode attached to the anode current collector, wherein the anode is formed using an anode material;
a solid electrolyte formed using an electrolyte material;
a gradational interface located between the solid electrolyte and the anode, wherein:
the gradational interface comprises a mixture of the electrolyte material and the anode material; and
the gradational interface comprises a greater percentage of the electrolyte material in a first portion of the gradational interface contacting the solid electrolyte than a second portion of the gradational interface contacting the anode;
a cathode; and
a cathode current collector.

2. The solid-state battery cell of claim 1, wherein the gradational interface comprises a greater percentage of the anode material in the second portion of the gradational interface contacting the anode than the first portion of the gradational interface contacting the solid electrolyte.

3. The solid-state battery cell of claim 1, wherein the mixture of the gradational interface is a continuous gradient mixture from being exclusively composed of anode material contacting the anode to being exclusively composed of solid electrolyte material contacting the solid electrolyte.

4. The solid-state battery cell of claim 1, wherein the mixture of the gradational interface is a stepped gradient mixture comprising a plurality of layers, wherein each layer is comprised of a different percentage of the anode material.

5. The solid-state battery cell of claim 1, further comprising:
a second gradational interface located between the solid electrolyte and the cathode, wherein:
the second gradational interface comprises a second mixture of the electrolyte material and a cathode material; and
the gradational interface comprises a greater percentage of the electrolyte material in a first portion of the second gradational interface contacting the solid electrolyte than a second portion of the second gradational interface contacting the cathode.

6. The solid-state battery cell of claim 5, wherein the second gradational interface comprises a greater percentage of the cathode material in the second portion of the second gradational interface contacting the cathode than the first portion of the gradational interface contacting the solid electrolyte.

7. The solid-state battery cell of claim 6, wherein the mixture of the second gradational interface is a continuous gradient mixture from being exclusively composed of cathode material contacting the cathode to being exclusively composed of solid electrolyte material contacting the solid electrolyte.

8. The solid-state battery cell of claim 7, wherein the mixture of the second gradational interface is a stepped gradient mixture comprising a plurality of layers, wherein each layer is comprised of a different percentage of the cathode material.

9. The solid-state battery cell of claim 1, wherein the solid-state battery cell is a lithium ion solid-state battery cell.

10. A method for creating an electrolyte interface for a solid-state battery, the method comprising:
creating an anode made from an anode material;
creating an interface layer between the anode and an electrolyte layer, comprising:
creating a first mixture of the anode material and an electrolyte material;
creating a second mixture of the anode material and the electrolyte material, wherein the first mixture has a greater concentration of anode material than the second mixture;
depositing the first mixture on the anode;
depositing the second mixture on the first mixture;
creating the electrolyte layer using the electrolyte material; and
creating a cathode using a cathode material.

11. The method for creating the electrolyte interface for the solid-state battery of claim 10, the method further comprising:
placing the electrolyte layer in contact with the second mixture.

12. The method for creating the electrolyte interface for the solid-state battery of claim 10, wherein the interface layer is a stepped gradient mixture comprising a plurality of layers, wherein each layer is comprised of a different percentage of the anode material.

13. The method for creating the electrolyte interface for the solid-state battery of claim 10, further comprising:
creating a second interface layer between the cathode and the electrolyte layer, comprising:
creating a third mixture of the cathode material and the electrolyte material; and
creating a fourth mixture of the cathode material and the electrolyte material, wherein the third mixture has a greater concentration of cathode material than the fourth mixture.

14. The method for creating the electrolyte interface for the solid-state battery of claim 13, further comprising:
depositing the fourth mixture on the electrolyte layer; and
depositing the third mixture on the fourth mixture.

15. The method for creating the electrolyte interface for the solid-state battery of claim 14, wherein the second interface layer is a second stepped gradient mixture comprising a plurality of layers, wherein each layer is comprised of a different percentage of the cathode material.

16. The method for creating the electrolyte interface for the solid-state battery of claim 15, further comprising:
placing the cathode in contact with the third mixture.

17. The method for creating the electrolyte interface for the solid-state battery of claim 16, further comprising:
placing a cathode current collector in contact with the cathode.

18. The method for creating the electrolyte interface for the solid-state battery of claim 17, wherein the method creates a lithium ion solid-state battery cell.

19. A method for creating an electrolyte interface for a solid-state battery, the method comprising:
creating a cathode made from a cathode material;
creating an interface layer between the cathode and an electrolyte layer, comprising:
creating a first mixture of the cathode material and an electrolyte material;
creating a second mixture of the cathode material and the electrolyte material, wherein the first mixture has a greater concentration of cathode material than the second mixture;
depositing the first mixture on the cathode;
depositing the second mixture on the first mixture; and
creating the electrolyte layer using the electrolyte material.

20. The method for creating the electrolyte interface for the solid-state battery of claim 19, wherein the interface layer is a stepped gradient mixture comprising a plurality of layers, wherein each layer is comprised of a different percentage of the cathode material.
